(19) United States
(12) Patent Application Publication
(10) Pub. No.: US 2017/0117592 A1
(43) Pub. Date: Apr. 27, 2017

(54) DEEP-DISCHARGE CONDITIONING FOR LITHIUM-ION CELLS

(71) Applicant: Navitas Systems, LLC, Woodridge, IL (US)

(72) Inventors: Pu Zhang, Ann Arbor, MI (US); Viet H. Vu, Canton, MI (US); Hongxia Zhou, Ann Arbor, MI (US); Patrick L. Hagans, Cleveland Heights, OH (US); Michael Wixom, Ann Arbor, MI (US)

(21) Appl. No.: 15/400,063

(22) Filed: Jan. 6, 2017

Related U.S. Application Data
(63) Continuation of application No. 14/501,521, filed on Sep. 30, 2014.
(60) Provisional application No. 61/884,487, filed on Sep. 30, 2013.

(51) Int. Cl. H01M 10/44; H01M 10/0525

(52) U.S. Cl. CPC H01M 10/44; H01M 10/0525

(57) ABSTRACT

A process of reconditioning a lithium-ion cell is provided that unexpectedly improves cell capacity, reduces cold temperature impedance and increases cold cranking amps. The process involves a reconditioning step of holding a cell at a sub-discharge voltage for a recovery time. The sub-discharge voltage is 1.0V or less in many embodiments, optionally 0.0V. Holding this sub-discharge voltage for a recovery time of several hours will result in recovery of lost capacity that is in excess of that explainable by recovery of ions transferred to an anode overhang.

### CROSS REFERENCE TO RELATED APPLICATIONS

This application is a continuation of U.S. patent application Ser. No. 14/501,521 filed Sep. 30, 2014 and which depends from and claims priority to U.S. Provisional Application No. 61/884,487 filed Sep. 30, 2013, the entire contents of each of which are incorporated herein by reference.

### FIELD OF THE INVENTION

The invention relates to batteries and method for improving cell performance and cycle life. More specifically, the invention relates to methods for renewing capacity lost during cycling of rechargeable batteries such as lithium ion batteries.

### BACKGROUND OF THE INVENTION

Rechargeable lithium-ion batteries are increasingly used in essential applications such as powering electric/hybrid vehicles, cellular telephones, and cameras. Recharging these battery systems is achieved using electrical energy to reverse the chemical reaction between and at the electrodes used to power the device during battery discharge thereby priming the battery to be capable of delivering additional electrical power.

One problem with these rechargeable systems is a reduction of battery capacity over several cycles of recharging. Capacity fade during cycling is generally inevitable for a lithium-ion battery. The power performance of lithium ion cells is limited by electrode materials, electrode design, electrode impedance, electrolyte composition and other lesser known reasons. There are many specific potential mechanisms for capacity fade during cycling. Irreversible capacity loss may be attributed to a loss of cycleable lithium. During charge/discharge cycles, some of the lithium ions may be converted into LiF or Li₂CO₃. Irreversible capacity losses may also be the result of anode disaggregation as a result of physical changes in electrode shape or volume during cycling.

Other reversible mechanisms may responsible for capacity fade during cycling. For example, during cycling a solid electrolyte interface (SEI) is formed. The presence of significant SEI can result in disconnection between anode particles reducing their ability to absorb/desorb lithium ions. Related to this problem is the buildup of additional SEI during cycling due to volume expansion and contraction of the anode material. The repeated expansion/contraction will fracture the SEI leading to infiltration of more material and additional SEI buildup. As the SEI layer increases in thickness, greater impedance is observed from a kinetic loss of accessible capacity. Another mechanism for capacity loss may be from cells designed with an anode overhang. A larger anode surface area relative to cathode surface area can cause migration of lithium ions into the overhang space during a high state of charge. This reduces the available lithium to readily be moved back to the cathode during discharge.

Many of these problems are being addressed by the development of new electrode materials and new electrode technology. One example of this is the substitution of new anode materials. A historically common anode material is graphite. During charging of the cells, lithium is inserted into the graphite (lithiation, forming LiC₆, with a capacity of about 372 mAh/g) and extracted from the graphitic carbon during discharging (de-lithiation). Other materials have much better theoretical capacity than graphite. Silicon is capable of alloying with relatively large amounts of lithium and has a number of advantages as an anode material for lithium ion batteries. Silicon has a theoretical capacity of 4200 mAh/g, and tin has a theoretical capacity of 994 mAh/g. Silicon, however, expands volumetrically by up to 400% on full lithium insertion (lithiation), and it can contract significantly on lithium extraction (delithiation), creating two critical challenges: (1) minimizing the mechanical degradation of silicon structure in electrode; and (2) maintaining the stability of the SEI. Stress induced by large changes in the volume of silicon anodes causes cracking and pulverization. This volume change is very disadvantageous in most battery systems since it can cause a loss of capacity, decrease cycle life, and cause mechanical damage to the battery structure.

Historically, addressing problems of capacity loss involved a search for new materials or cell configurations, each of which is complex and expensive. The cycle life fade of the lithium ion battery, however, is still limited by the nature of the cell chemistry and electrode design. As such, new methods are needed for producing a safe, high performance rechargeable battery.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The invention provides processes of reconditioning an electrochemical cell to recapture capacity lost during cycling. The process includes holding a lithium-ion cell at a sub-discharge voltage of 2.0 Volts or less for a recovery time sufficient to show an increased capacity or reduced impedance relative to an untreated cell. The treatment will recover significant capacity lost during cycling, optionally 2 percent or greater capacity is recovered according to specific embodiments.

A sub-discharge voltage depends on the cell type used and is below that normally used as a recognized operational discharge voltage for the specific cell type. Optionally, a sub-discharge voltage is 1.8 Volts or less, optionally, 1.5 Volts or less, optionally, 1.0 Volt or less. Particular aspects hold a cell at 0 V for a recovery time. The recovery time allows the cell to recapture lost capacity when held at the sub-discharge voltage. A recovery time is optionally 1 hour or greater, optionally 24 hours or greater, optionally 72 hours or greater. In some embodiments, a recovery time is 120 hours. In particular aspects, a process includes holding a cell at a sub-discharge voltage of less than 2.0 Volts for a recovery time is 24 hours or greater. In some aspects, a recovery time is 120 hours or less, optionally 72 hours or less, optionally 24 hours or less. A recovery time is optionally from 1 from 120 hours, optionally from 1 to 72 hours, optionally from 1 to 24 hours, optionally from 24 hours to 120 hours, optionally from 24 to 72 hours.

Also provided are processes of improving cycle life of lithium-ion cell including cycling a lithium-ion cell between a charge voltage and a discharge voltage for a first cycling period, then holding the lithium-ion cell at a sub-discharge voltage of 2.0 Volts or less for a recovery time sufficient to show an increased capacity. The first cycling period is optionally from 50 to 250 cycles. The process optionally increases capacity by 2% or greater following the recovery time relative to a cell that does not undergo the process. Optionally, a sub-discharge voltage is 1.8 Volts or less, optionally, 1.5 Volts or less, optionally, 1.0 Volt or less. Particular embodiments hold a cell at 0 V for a recovery time. A recovery time is optionally 1 hour or greater, optionally 24 hours or greater, optionally 72 hours or greater. In some embodiments, a recovery time is 120 hours. In particular embodiments, a process includes holding a cell at a sub-discharge voltage of less than 2.0 Volts for a recovery time of 24 hours or greater. A cell is optionally used for a second cycling period following which a holding step is repeated to once again recover capacity lost during the second cycling period. The second capacity recovered is optionally 2% or greater relative to a cell that does not undergo any treatment or only undergoes a first or prior holding step only. A second cycling period is optionally equal to the first cycling period. In some embodiments, a first cycling period and a second cycling period are from 50 to 250 cycles, optionally 150 cycles.

Also provided are processes of reducing impedance, optionally cold temperature impedance, in an electrochemical cell, optionally a lithium-ion cell, where the process includes holding a cell at a sub-discharge voltage of 2.0 Volts or less for a recovery time sufficient to show reduced impedance relative to an untreated cell. The treatment will reduce the DC impedance significantly at 25° C. or at −20° C. At 25° C., a process optionally reduces DCR optionally by greater than 20%, optionally from 10% to 30%, optionally 25% or more. At −20° C., a process optionally reduces DCR by 5% to 10%, optionally greater than 5%, optionally greater than 7%. Optionally, a sub-discharge voltage is 1.8 Volts or less, optionally, 1.5 Volts or less, optionally, 1.0 Volt or less. Particular embodiments hold a cell at 0 V for a recovery time. The treatment includes holding a cell at a sub discharge voltage for a recovery time. A recovery time is optionally 1 hour or greater, optionally 24 hours or greater, optionally 72 hours or greater. In some embodiments, a recovery time is 120 hours. In particular embodiments, a process includes holding a cell at a sub-discharge voltage of less than 2.0 Volts for a recovery time of 24 hours or greater. In some aspects, a recovery time is 120 hours or less, optionally 72 hours or less, optionally 24 hours or less. A recovery time is optionally from 1 from 120 hours, optionally from 1 to 72 hours, optionally from 1 to 24 hours, optionally from 24 hours to 120 hours, optionally from 24 to 72 hours.

Also provided are processes of increasing cold cranking amperes optionally at −20° C. A process includes holding a cell at a sub-discharge voltage of 2.0 Volts or less for a recovery time sufficient to show an increase in CCA relative to an untreated cell. The treatment will increase CCA at −20° C. by 1% or greater, optionally 5% or greater, optionally 8% or greater. Optionally, a sub-discharge voltage is 1.8 Volts or less, optionally, 1.5 Volts or less, optionally, 1.0 Volt or less. Particular embodiments hold a cell at 0 V for a recovery time. A recovery time is optionally 1 hour or greater, optionally 24 hours or greater, optionally 72 hours or greater. In some embodiments, a recovery time is 120 hours. In particular embodiments, a process includes holding a cell at a sub-discharge voltage of less than 2.0 Volts for a recovery time of 24 hours or greater. In some aspects, a recovery time is 120 hours or less, optionally 72 hours or less, optionally 24 hours or less. A recovery time is optionally from 1 from 120 hours, optionally from 1 to 72 hours, optionally from 1 to 24 hours, optionally from 24 hours to 120 hours, optionally from 24 to 72 hours.

### BRIEF DESCRIPTION OF THE DRAWINGS

FIG. 1 illustrates capacity recovery after various protocols of cell conditioning; and

FIG. 2 illustrates improvements in capacity over greater than 1000 cycles with a reconditioning step included periodically.

### DETAILED DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

The problem of capacity fade during cycling is observed in all lithium-ion rechargeable battery systems. The present invention provides a unique and inexpensive method of renewing cell capacity or reducing cell impedance without the need for employing new materials or battery configurations. A method for increasing the capacity, reducing the low temperature impedance, or improving cold-cranking amps in a battery suffering from capacity fade is provided. The method includes holding the battery at a sub-discharge voltage for a recovery time. The inventors demonstrate that conditioning a lithium-ion cell at a sub-discharge voltage can recover greater than 100% of the post-formation capacity loss.

A process includes holding a battery at a sub-discharge voltage. A discharge voltage is typically 2.7 V for a cell with a lithium metal oxide cathode or 2.0V for a cell with a lithium metal phosphate cathode. A sub-discharge voltage according to the invention is less than 2.7 volts. Optionally, a sub-discharge voltage is less than 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 V. In many embodiments, a sub-discharge voltage is 2.0 V or less. Optionally, a sub-discharge voltage is from 0V to 2.0V or any value or range therebetween. In some embodiments, a sub-discharge voltage is 0V or as closely achievable to 0 V to be considered substantially 0V.

A sub-discharge voltage is held over the battery suffering from capacity fade for a recovery time. A recovery time is a time sufficient to produce any increase in capacity or low temperature power performance relative to that of the pre-conditioned battery. A recovery time is optionally 1 hour to 120 hours or any value or range therebetween. It is appreciated that longer recovery times may be used. A recovery time is optionally from 24 hours to 120 hours, optionally 72 hours to 120 hours, optionally 24 to 72 hours. A recovery time is optionally 1, 2, 3, 4, 5, 6, 7, 8, 9, 10, 11, 12, 13, 14, 15, 16, 17, 18, 19, 20, 21, 22, 23, 24, 36, 48, 60, 72, 80, 90, 100, or 120 hours. In some aspects, a recovery time is 120 hours or less, optionally 72 hours or less, optionally 24 hours or less. A recovery time is optionally from 1 from 120 hours, optionally from 1 to 72 hours, optionally from 1 to 24 hours, optionally from 24 hours to 120 hours, optionally from 24 to 72 hours.

The holding step increases the capacity of the cell 1.8% or greater relative to the cell prior to the holding step. Optionally, the holding step increases the capacity from 1.8% to 5% relative to the cell prior to the holding step.

A process optionally includes a stepwise reconditioning. A stepwise reconditioning includes a first reconditioning step including holding the battery at a first sub-discharge voltage for a first recovery time. A stepwise reconditioning includes a second reconditioning step including holding the battery at a second sub-discharge voltage for a second recovery time. A second recovery step is optionally performed immediately following a first reconditioning step or following a delay that does not involve bringing the cell to a high SOC. A second sub-discharge voltage is optionally lower than a first sub-discharge voltage. Optionally, a first sub-discharge voltage is less than 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 V. A second sub-discharge voltage is optionally less than a first sub-discharge voltage by 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 V. A second sub-discharge voltage is optionally 0V, or substantially 0V.

A first recovery time and a second recovery time may each be any time from 1 to 120 hours, or any value or range therebetween. A second recovery time is optionally identical to a first recovery time. Optionally, a second recovery time is less than a first recovery time. As an illustrative example, a first recovery time is optionally 120 hours, and a second recovery time is 48 hours.

Optionally, a third reconditioning step is used. A third reconditioning step includes holding a battery at a third-sub discharge voltage that is lower than a second sub-discharge voltage. A third sub-discharge voltage is optionally less than a second sub-discharge voltage by 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 V. A third sub-discharge voltage is optionally 0V, or substantially 0V.

Optionally, two or more reconditioning steps are included. Optionally, 2, 3, 4, 5, 6, 7, 8, 9, 10, 11, 12, or more reconditioning steps are included.

One problem associated with holding a lithium-ion battery at a sub-discharge voltage is the development of corrosion on the anode. This corrosion can be prevented by including an additive in the electrolyte. An additive is optionally succinonitrile (SN), polysulfide (PS), or combinations thereof. An additive is optionally present in an electrolyte in a concentration of 0.1% by weight to 4% by weight, or any value or range therebetween. Optionally, an additive is present at 0.5% to 3.5% by weight. Optionally, an additive is present at 0.9% to 3.5% by weight.

Also provided are processes of improving the cycle life of a battery. Improved cycle life is defined as increasing the number of cycles in which a battery can reach a recovered capacity of 80% or greater, optionally 98% or greater. A recovered capacity is optionally 80, 81, 82, 83, 84, 85, 86, 87, 88, 89, 90, 91, 92, 93, 94, 95, 96, 97, or 98% or greater of an initial post formation capacity. The process involves subjecting a cell undergoing cycling to one or more recovery steps. A recovery step is achieved by holding a lithium-ion cell at a sub-discharge voltage of 2.0 Volts or less for a recovery time sufficient to show an increased capacity or reduced cold temperature impedance, optionally, relative to an untreated cell or relative to prior to the holding step. The step of holding is performed one or more times in the cycle life of a cell. Optionally, a step of holding is performed every 50 to 250 cycles or any value or range therebetween. Optionally, a step of holding is performed every 100 to 200 cycles. Optionally, a step of holding is performed every 50, 60, 70, 80, 90, 100, 110, 120, 130, 140, 150, 160, 170, 180, 190, 200, 210, 220, 230, 240, or 250 cycles.

The process will reach a recovered capacity of 80% or greater for 400 cycles or more. Optionally, the process will reach a recovered capacity of 80% or greater for 400 to 1000 cycles. Optionally, the process will reach a recovered capacity of 80% or greater for 400, 500, 550, 600, 650, 700, 750, 800, 810, 820, 830, 840, 850, 860, 870, 880, 890, 900, 910, 920, 930, 940, 950, 960, 970, 980, 990, or 1000 cycles or more.

Also provided are processes of reducing ambient temperature or cold temperature DC impedance in a lithium-ion cell are provided. When a cell is subjected to a single or stepwise conditioning step(s) as described above, the processes reduce DCR by greater than 20%, optionally from 10% to 30%, optionally 25% or more. At −20° C., a process optionally reduces DCR by 5% to 10%, optionally greater than 5%, optionally greater than 7%. It is appreciated that the above described conditions of sub-discharge voltage and recovery time are equally operable in a process of reducing DCR in an electrochemical cell.

Also provided are processes increasing cold cranking amps (CCA) in a lithium-ion cell are provided. A cell at a cold temperature, optionally less than 0° C., −5° C., −10° C., −15° C., −20° C. or lower, is subjected to a single or stepwise conditioning step(s) as described above, optionally multiple conditioning steps. Holding a cell at a sub-discharge voltage for a recovery time will increase CCA by 1% or greater. Optionally, CCA is increased by 2%, 3%, 4%, 5%, 6%, 7%, 8%, 9%, 10%, or greater relative to a cell that does not undergo a process. Optionally, CCA is increased by 5%-10%. Optionally, CCA is increased by 8%-10%. It is appreciated that the above described conditions of sub-discharge voltage and recovery time are equally operable in a process of reducing DCR in an electrochemical cell.

The processes provided improve the cycle life of a battery by maintaining high capacity for many additional cycles relative to an untreated cell. Also, the processes reduce DC resistance at low temperatures and improve cold cranking amps. Overall, significantly improved battery performance can be achieved without the need for development of new cell structures or components.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### EXPERIMENTAL

An electrochemical cell is assembled. The cell cathode was fowled from 92wt % lithium iron phosphate (LFP), 4 wt % conductive carbon, and 5 wt % polyvinylidene fluoride (PVDF) dispersed in N-Methyl-2-pyrrolidone (NMP) and mixed. The slurry was casted on aluminum foil. The cathode material was dried, calendered, and then pouched with matched-metal die to form the positive electrode. An aluminum strip was welded to the foil to serve as positive terminal.

The anode was constructed of 94wt % graphite, 1 wt % conductive carbon, and 5 wt % polyvinylidene fluoride (PVDF) dispersed in N-Methyl-2-pyrrolidone (NMP) that was mixed and the resulting slurry casted on copper foil. The anode material was dried, calendared, and then pouched with matched-metal die to form the negative electrode. Nickel strip was welded to the copper foil to serve as the negative terminal.

Two of the resulting cells have dimensions as illustrated in Table 1.

TABLE 1

| | Anode | | Cathode | | Area | |
|---|---|---|---|---|---|---|
| Measured | dimension | Anode Area | dimension | Cathode Area | Difference | % Anode |
| Foot print | (mm) | (mm²) | (mm) | (mm²) | (mm²) | Overhang |
| 20 Ahr | 151 × 199 | 30,049 | 148 × 194 | 28,712 | 1337 | 4.45-8.27 |
| X3450 | 32.5 × 46.0 | 1495 | 31.4 × 45.0 | 1412 | 82 | 5.48 |

*The 8% value includes the outer anode back planes.

For the majority of tests, cells were constructed with an anode overhang of 5.5%. The cathode and anode were stacked with a separator of porous polyethylene (20 μm thick) and vacuum dried at 70° C. for 2 days before transferring to a glove box. An electrolyte material is added to the cell. Cells are constructed using a lithium fluoride, lithium methoxide, lithium carbonate, or lithium oxalate electrolyte.

The cells are tested for capacity and cycle life using both steady state experiments and sweep experiments. For steady state experiments, cells were swept to a high state of charge (SOC) of 3.6V, held for 72 hours, and discharged to a target sub-discharge voltage of either 2V or 0V for a test time. The percent of charge recovered after the test time is then determined. Each experimental set is repeated using three cells in duplicate. The resulting capacity recovered is illustrated in Table 2:

| Time at whatever | % Charge Recovered vs. Input | |
|---|---|---|
| discharge voltage | after 72 hours at 3.6 V | |
| (hrs) | 2.0 V | 0.0 V |
| 24 | 105.2 | 107.4 |
| 48 | 105.6 | 107.2 |
| 120 | 105.8 | 109.6 |

Given the 5.5% anode overhang these data indicate that the capacity lost due to anode overhang is recovered at a low SOC of 2.0V. However, reducing the SOC to 0.0V for a test time allows for the recovery greater than the charge lost due to ion migration into the overhang area indicating improved capacity recovery even with a recovery time of only 24 hours.

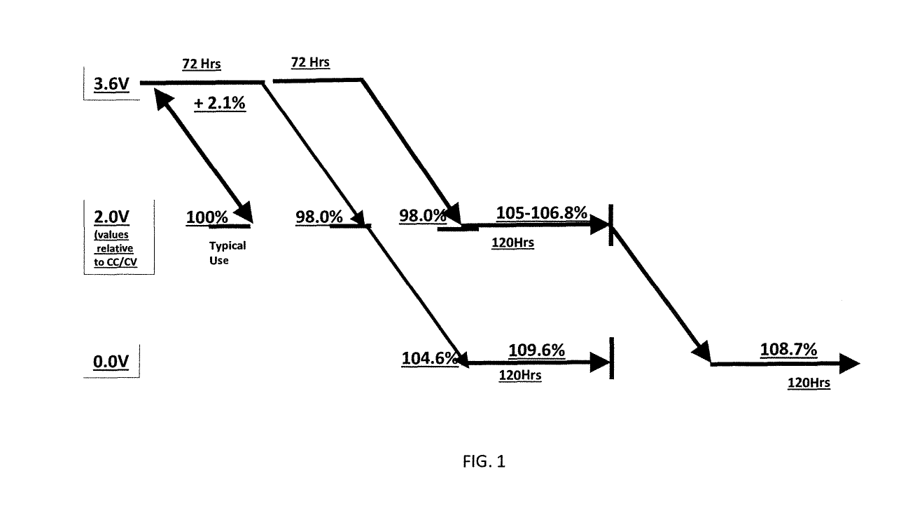

A second set of experiments was performed on freshly prepared cells by sweep testing methods. The cells were charged to a high SOC of 3.6V and held for 0 or 72 hours. The cells were then discharged at 1 C/2 C to 2V and held for 0 to 120 hours. The capacity recovery was calculated. Cells were then swept to an SOC of 0.0V for a recovery time and the capacity determined. FIG. 1 illustrates the experimental protocol. The calculated capacity recovery under typical use conditions where the high SOC was not held, but immediately discharged to a low SOC (2V in this case), was the expected 100% capacity recovery. Holding the cell for a hold time of 72 hours in a SOC of 3.6V recovered approximately 98% of capacity at 2V. Holding the cell for a recovery time at the low SOC of 2.0V for 120 hours allowed recovery of greater than 105% of capacity. The cells were then swept to 0.0V. The immediate capacity recovered was determined to be 104.6%. Holding the cells at 0.0V for 120 hours for cells that were immediately discharged or held at 2.0V produced a capacity recovery of 109.6% and 108.7% respectively. These data demonstrate that both steady state measurements and with an intermediate step, sweeping to 0.0V allows greater than expected capacity recovery.

Similar step-wise discharge experiments were repeated using a set of intermediate low SOC hold steps. Fresh cells are charged to 3.6V and held for 72 hours. These cells are then discharged to 2.0V and held for 120 hours for a first recovery time. At the beginning of the 2.0V hold time, the capacity recovery was 100.5%. After 120 hours of recovery time the capacity recovered was 107.2%. The cells were then discharged to an SOC of 1.5V. The capacity recovered was increased to 107.3% immediately. After a second 120 recovery hold time, the capacity recovered was 108.2%. These cells were then discharged to a low SOC of 1.0V. The immediate capacity recovery was not improved showing 108.2%. After a hold time of 48 hours, the capacity recovery was increased to 109.6%.

Overall, these experiments demonstrate that capacity recovery is greater than expected when cells are subjected to a sub-discharge voltage for a recovery time. This capacity recovery is greater than that expected if the recovery was due to recapture of ions that migrated to the anode overhangs. Subsequent testing demonstrated that the process was unable to recover the lost formation capacity, however, indicating that while greater than expected capacity was recovered after a sub-discharge voltage treatment, the formation capacity was irrevocably lost.

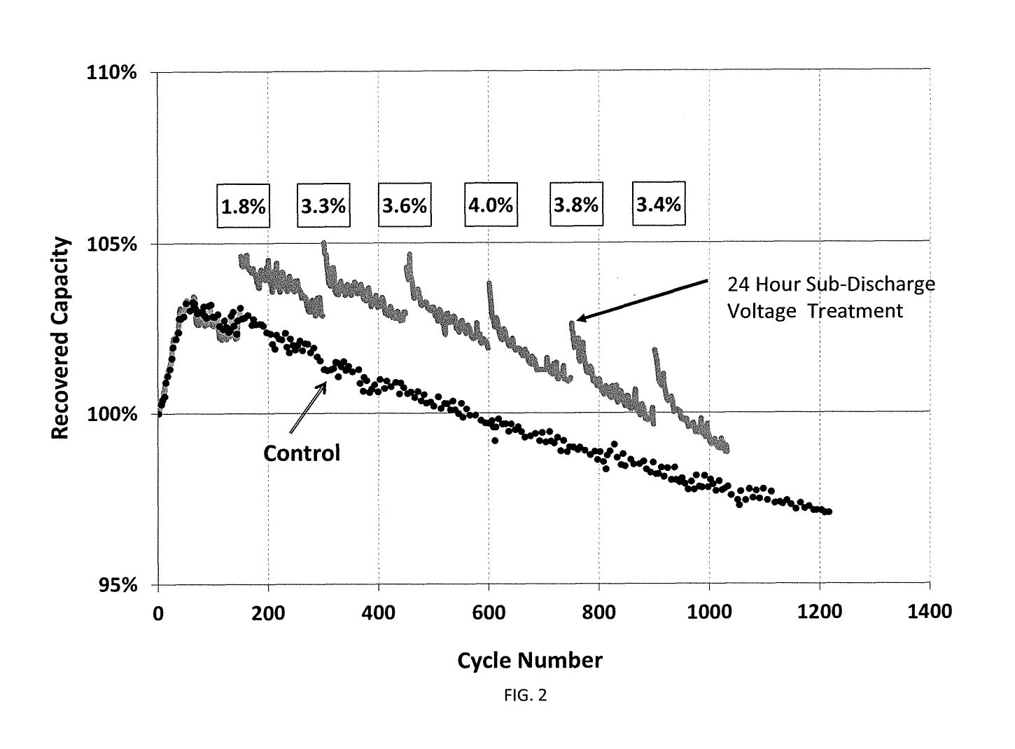

Cells constructed as above were subjected to cycling experiments to determine if the capacity gains are maintained over several cycles. The cells are cycled between 3.6V and 2.0V. A first set of cells was cycled continuously for 1500 cycles with capacity recovery determined each cycle. A second set of cells was subjected to a sub-discharge voltage treatment at 0.0V for 24 hours every 150 cycles. The results are demonstrated in FIG. 2. The treatment at sub-discharge voltage led to a significant recovery of capacity that was 1.8% to 4.0% relative to control. The initial capacity gain rapidly fell to a sub-peak level typically 2% greater than control, but then was lost at rates indistinguishable from control thereby maintaining the approximately 2% improvement. Repeating the sub-discharge voltage treatments maintained the improved capacity out to greater than 1000 cycles.

Low temperature direct current resistance (DCR) and cold cranking amps (CCA) were determined to elucidate whether the sub-discharge voltage treatment improves either parameter. An improvement means lowering the DCR or increasing the CCA. Cells constructed as above were swept to a high SOC of 3.6V, held for 72 hours and discharged at C/2 to a target sub-discharge voltage of 0V for a test time of 24 hours. The cells were incubated either at ambient temperature (25° C.) or subjected to cold treatment at −20° C. The DCR and CCA after the test time were then determined. To perform the DCR test, a cell was fully charged and then discharged to 50% depth-of-discharge (DOD) at 0.3 C rate at 25° C. Then it was discharged at 3 C for 10 seconds at 25° C. or −20° C. DCR was calculated as ΔV (cell voltage difference before and after 10 seconds)/I (3 C current). To perform the CCA test, a cell was fully charged at 25° C. and then discharged at constant voltage of 1.875V for 10 seconds at −20° C. The current (amps) at the end of 10 seconds was recorded as CCA. The results are illustrated in Table 3.

TABLE 3

| | | | | | | | 10 sec CCA at | | |
|---|---|---|---|---|---|---|---|---|---|
| | RT DCR (Ω) | | | DCR at −20° C. (Ω) | | | −20° C. (A) | | |
| | Before | After | % | Before | After | % | Before | After | % |
| Cell | 0 V | 0 V | Change | 0 V | 0 V | Change | 0 V | 0 V | Change |
| AW415_109_TEL4_7 | 0.114 | 0.081 | −28.9 | 0.963 | 0.896 | −7.00 | 1.80 | 1.97 | 8.63 |
| AW415_109_TEL4_8 | 0.114 | 0.082 | −29.0 | 0.959 | 0.886 | −7.61 | 1.83 | 2.03 | 9.86 |
| AW415_109_TEL4_10 | 0.115 | 0.082 | −28.7 | 0.968 | 0.895 | −7.54 | 1.77 | 1.96 | 9.70 |
| Average | 0.114 | 0.082 | −28.6% | 0.963 | 0.892 | −7.38% | 1.80 | 1.99 | +9.40% |

Cells tested at ambient temperature showed a DCR of 0.114 ohms on average. Treatment with a sub-discharge voltage for 24 hours reduced the DCR to an average of 0.082 ohms illustrating an excellent 28.6% improvement. Cells subjected to the same testing at −20° C. showed a lower improvement, but allowed the cells to perform substantially as if they were present at ambient temperature. Similarly, CCA at −20° C. is significantly improved by sub-discharge voltage treatment with test cells showing a 9.4% improvement in CCA.

Overall these data demonstrate better than expected capacity gain that exceeds any gains that may be derived from a recapture of ions lost in the anode overhang. This additional capacity is retained at a level of 3% greater than expected relative to cells that do not undergo the treatment. Also, the treatment results in a 10% reduction in DCR at low temperatures and an increase in CCA. The treatment at sub-discharge voltage for a recovery time, therefore, significantly and unexpectedly improves overall battery performance.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof

We claim:

1. A process for reconditioning an electrochemical cell comprising:
cycling a lithium-ion cell to an operational discharge voltage 50 or more times;
cycling the lithium-ion cell to a sub-discharge voltage of less than 2.0 Volts;
holding the lithium-ion cell at the sub-discharge voltage for a recovery time sufficient to increase capacity of the lithium-ion cell.

2. The process of claim 1 wherein said capacity is increased 2 percent or greater.

3. The process of claim 1 wherein said sub-discharge voltage is 1.0 Volts or less.

4. The process of claim 1 wherein said sub-discharge voltage is 0 Volts.

5. The process of claim 1 wherein said recovery time is 1 hour or greater.

6. A process increasing cranking amperes of an electrochemical cell at a temperature less than 25 degrees Celsius comprising:
cycling a lithium-ion cell to an operational discharge voltage 50 or more times;
holding the lithium-ion cell at a sub-discharge voltage of 2.0 Volts or less for a recovery time sufficient to increase cranking amperes of an electrochemical cell at 0 degrees Celsius or lower.

7. The process of claim 6 wherein said cranking amperes is increased 1 percent or greater.

8. The process of claim 6 wherein said temperature is -20 degrees Celsius or lower.

9. The process of claim 6 wherein said sub-discharge voltage is 1.0 Volts or less.

10. The process of claim 6 wherein said sub-discharge voltage is 0 Volts.

11. The process of claim 6 wherein said recovery time is 1 hour or greater.

12. The process of claim 6 wherein said sub-discharge voltage is less than 2.0 Volts and said recovery time is 24 hours or greater.

13. A process of increasing cycle life of a lithium-ion cell comprising:
cycling a lithium-ion cell between a charge voltage and an operational discharge voltage for a first cycling period of 50 to 250 cycles; and
holding said lithium-ion cell at a sub-discharge voltage of 2.0 Volts or less for a recovery time sufficient to show an increased capacity for 10 or more cycles.

14. The process of claim 13 wherein said capacity is increased 2 percent or greater.

15. The process of claim 13 wherein said sub-discharge voltage is 1.0 Volt or less.

16. The process of claim 13 wherein said recovery time is from 24 to 120 hours.

17. The process of claim 13 further comprising cycling said lithium-ion cell for a second cycling period; and
repeating said step of holding.

18. The process of claim 17 wherein said first cycling period and said second cycling period are each from 50 to 250 cycles.

19. The process of claim 17 wherein said holding steps are at a voltage of 1.0 Volt or less.
